(19) United States
(12) Patent Application Publication
(10) Pub. No.: US 2005/0050742 A1
(43) Pub. Date: Mar. 10, 2005

(54) Combined cosmetic pencil holder and sharpener

(76) Inventors: John Maldonado, Venice, CA (US); Victoria Wood, Venice, CA (US)

Correspondence Address: Christopher J. McDonald;HOFFMAN, WASSON & GITLER, P.C., Suite 522, 2461 South Clark Street, Arlington, VA, 22202, US

(21) Appl. No.: 10/937,342

(22) Filed: Sep. 10, 2004

Related U.S. Application Data
(60) Provisional application No. 60/501,421, filed on Sep. 10, 2003.

(51) Int. Cl. B43L 23/00

(52) U.S. Cl. 30/458; 30/451

(57) ABSTRACT

The cosmetic pencil holder and sharpener has a body with a top surface formed with pencil holders. A pencil sharpener formed by a slot in the sidewall and blade allow shavings to fall into a hinged domed cover. A guide in the cover directs shavings away from the blade to prevent clogging. A back lid accommodates a mirror.

This application claims the benefit of U.S. Provisional Patent Application Ser. No. 60/501,421, filed Sep. 10, 2003.

### BACKGROUND OF THE INVENTION

A common way to apply make-up is with a cosmetic pencil. The pencil is made of wood with a core of cosmetic material, such as wax. As with any type of pencil, use causes the point to become dull and require sharpening. Often, pencils are carried with the person so that it may be used at any time. However, having the pencil serves no purpose if it is not sharp enough to be used.

It is an object of the invention to provide a combined pencil holder and sharpener.

It is another object of the invention to provide a holder and sharpener for cosmetic pencils able to retain and sharpen a variety of pencil sizes.

It is another object of the invention to provide a pencil holder and sharpener having a mirror.

These and other objects of the invention will become apparent to one of ordinary skill in the art after reading the disclosure of the invention.

### SUMMARY OF THE INVENTION

The cosmetic pencil holder and sharpener has a body with a top surface formed with pencil holders. A pencil sharpener formed by a slot in the sidewall and blade allow shavings to fall into a hinged domed cover. A guide in the cover directs shavings away from the blade to prevent clogging. A back lid accommodates a mirror.

### BRIEF DESCRIPTION OF THE DRAWINGS

FIG. 1 shows a perspective view of the holder/sharpener with the domed cover open.

FIG. 2 shows a perspective view of the sharpener and holder with the dome cover closed and having two holders and two sharpeners.

FIG. 3 is a perspective view of the back of the holder.

FIG. 4 is a detailed view of the guide on the domed cover.

FIG. 5 is a perspective view of the pick.

### DETAILED DESCRIPTION OF THE INVENTION

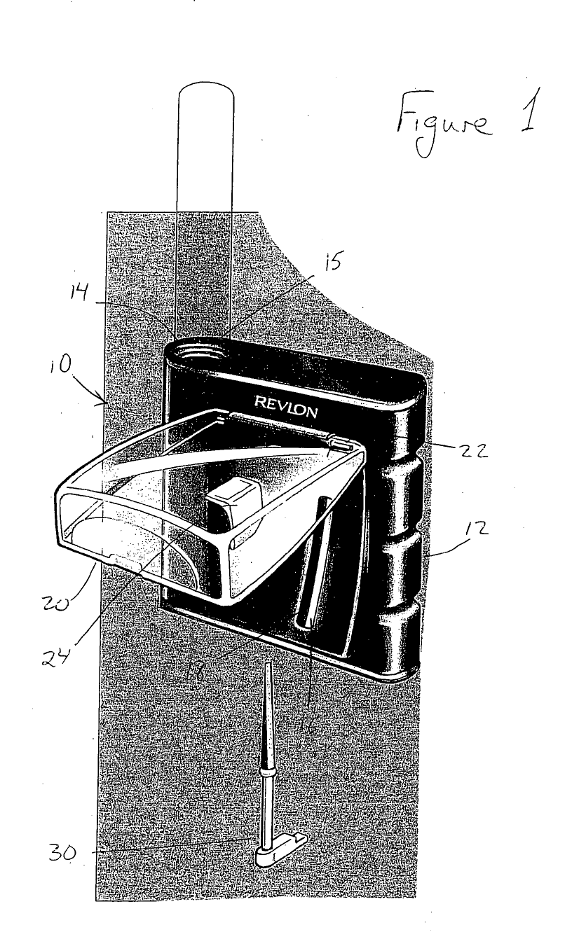

As seen in FIG. 1, the pencil holder and sharpener 10 is formed by a body having a top wall. The top wall has a bore 14 to receive a pencil. The internal surface of the bore has threads 15 to help retain the pencil. The bottom of the body 12 has a bore, not seen, into which the pencil is placed when needing sharpening. A stainless steel blade 16 forms one edge of a slot 18 in the side of the body. The slot is in communication with the sharpening bore.

A domed cover 20 is pivotably attached to the body by metal hinge 22. The domed lid covers the side of the body including the slot and provides a catch for the shavings when a pencil is being sharpened. A guide 24 is formed on the domed cover 20. In the closed position, the guide is situated next to the slot 18 and presents an arcuate surface contacting the shavings when coming through the slot 18.

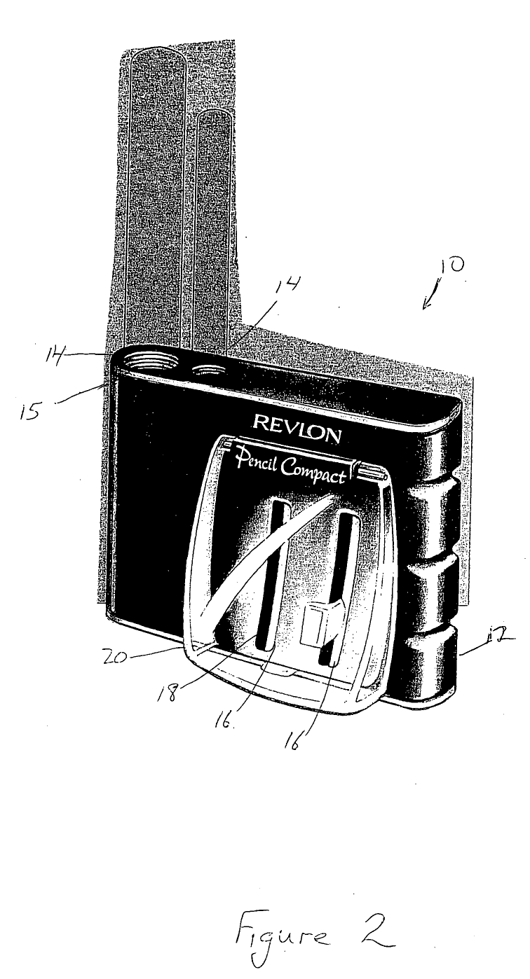

FIG. 2 shows a second embodiment of the holder/sharpener. In this embodiment, the top wall has two bores 14, each having threads 15 but being of a different diameter to accommodate different sized pencils. In keeping with this difference, the bottom wall has two sharpening bores, each communicating with a slot 18 having a blade 16 forming one edge. Similar to the bores 14 for holding the pencil, each of the sharpening bores is of a different diameter to accommodate different sized pencils. The diameters of the sharpening bores correspond to the diameters of the bores for holding the pencils.

FIG. 3 shows a back lid 36 hingedly connected to the back of the holder/sharpener. The inner surface of the back lid is provided with a mirror 38. Between the back of the holder/sharpener and the back lid is a shield 37 pivotably connected to the holder/sharpener. The shield protects the mirror from damage.

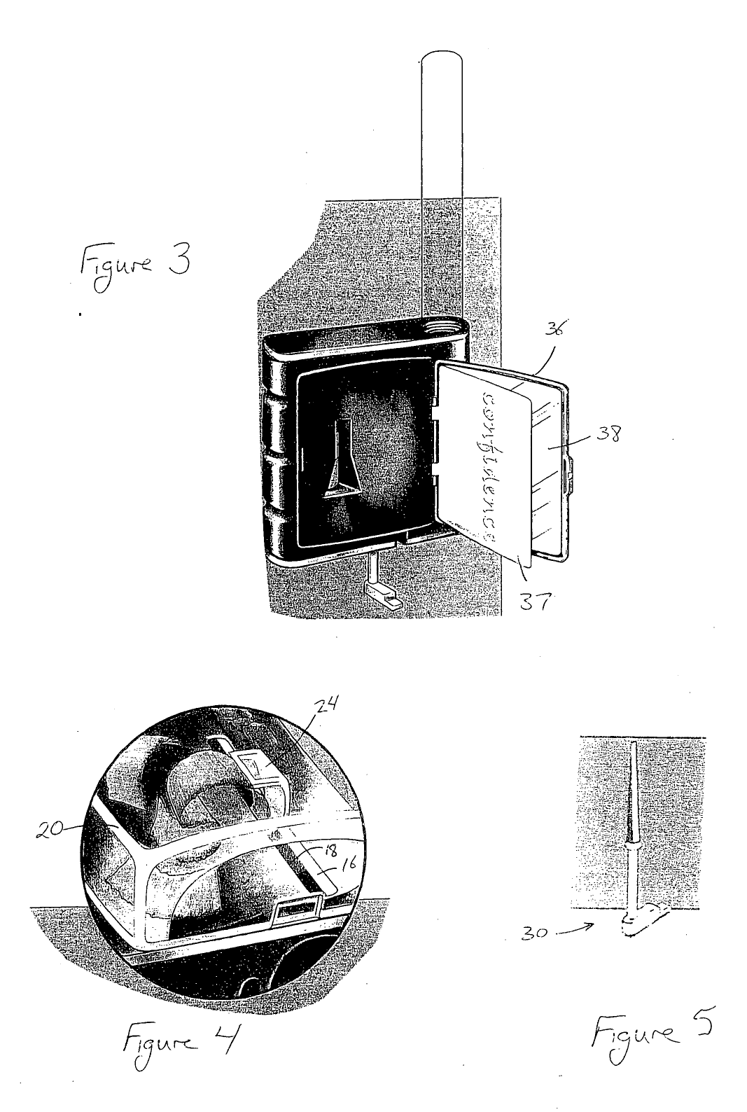

FIG. 4 shows in detail how the guide 24 is situated next to the slot 18 when the domed cover is closed. The arcuate surface of the guide 24 directs shavings away from the slot and prevents clogging of the slot with the shavings.

FIG. 5 shows a pick used to clean the slot and sharpening bores of any shavings. The pick has a chiseled point, preferably coated with a friction-reducing material, such as Teflon®. The handle is made of aluminum, or other similar durable material. The pick is retained in a bore formed in the bottom of the holder/sharpener when not in use.

While the invention has been described with reference to preferred embodiments, variations and modifications would be apparent to one of ordinary skill in the art. The invention covers such variations and modifications which do not depart from the scope of the invention.

1. A holder and sharpener for pencils, comprising
a body having a top wall, a bottom wall and a sidewall,
at least one bore for holding a pencil formed in said top wall,
at least one bore for sharpening a pencil formed in said bottom wall,
at least one slot formed in said sidewall, said at least one slot in communication with said at least one sharpening bore,
a blade forming one edge of said at least one slot, and
a domed lid hingedly attached to said sidewall, said domed lid covering said at least one slot when closed.

2. The holder and sharpener of claim 1, further comprising
two bores for holding a pencil in said top wall, each bore having a different diameter, and
two bores for sharpening a pencil in said bottom wall, each bore having a different diameter.

3. The holder of claim 1, further comprising
a back lid hingedly attached to said sidewall, said back lid having a mirror on its inner surface.

4. The holder and sharpener of claim 2, further comprising
two slots, each in communication with one of said bores for sharpening, and
a blade forming an edge of each slot.
